(19) United States
(12) Patent Application Publication
(10) Pub. No.: US 2026/0100315 A1
(43) Pub. Date: Apr. 9, 2026

(54) Switch with Electromechanical Actuator

(71) Applicant: Omar Chibli, Dallas, TX (US)

(72) Inventor: Omar Chibli, Dallas, TX (US)

(21) Appl. No.: 19/349,625

(22) Filed: Oct. 3, 2025

Related U.S. Application Data
(60) Provisional application No. 63/703,568, filed on Oct. 4, 2024.

(51) Int. Cl. H01H 3/26; E05B 47/00; H01H 1/20; H01H 1/50

(52) U.S. Cl. CPC H01H 3/264; E05B 47/0012; H01H 1/2041; H01H 1/50; E05B 2047/005

(57) ABSTRACT

An apparatus for controlling current in a circuit may include a motor, a leadscrew coupled to the motor, and an actuator arm coupled to the leadscrew. The apparatus may include a common terminal, a normally open terminal, a normally closed terminal, and a contact arm configured to couple the common terminal to the normally closed terminal in a first position and to the normally open terminal in a second position. A spring can bias the contact arm toward the first position, and the motor can be configured to operate the leadscrew to move the actuator arm, and the actuator arm can be configured to move the contact arm from the first position to the second position.

### PRIORITY CLAIM

This application claims the benefit of priority of U.S. Provisional Patent Application Ser. No. 63/703,568 titled “Switch with Electromechanical Actuator”, filed on Oct. 4, 202, whose inventor(s) is/are Omar Chibli, which is hereby incorporated by reference in its entirety as though fully and completely set forth herein.

### TECHNICAL FIELD

The invention set forth in the appended claims relates generally to switches, including, without limitation, switches operated by low-voltage electromechanical actuators.

### BRIEF SUMMARY

New and useful systems, apparatuses, and methods for controlling current in a circuit are set forth in the appended claims. In some embodiments, the systems, apparatuses, and methods for controlling current may be used to control an access point. Illustrative embodiments are also provided to enable a person skilled in the art to make and use the claimed subject matter.

For example, some embodiments of an apparatus for controlling current in a circuit may include a motor, a leadscrew coupled to the motor, and an actuator arm coupled to the leadscrew. The apparatus may additionally include a common terminal, a normally open terminal, a normally closed terminal, and a contact arm configured to couple the common terminal to the normally closed terminal in a first position and to the normally open terminal in a second position. A spring may be configured to bias the contact arm toward the first position. The motor may be configured to operate the leadscrew to move the actuator arm, and the actuator arm can move the contact arm from the first position to the second position.

In some embodiments, the motor may be a direct current motor configured to be operated at a range of about three volts to less than twelve volts, and preferably less than six volts. In more particular embodiments, the motor may be a micro-gear direct current motor capable of operating at about three hundred revolutions per minute and three volts. The motor may be coupled to a battery having a voltage in a range of about three volts to about six volts.

In some embodiments, a system for controlling an access point may include an electronic lock; a power supply; and a switch coupled to the electronic lock and the power supply. The switch may be configured to close a circuit between the electronic lock to the power supply in a first position and to open the circuit in a second position. A spring may be configured to bias the switch toward the first position. The system may additionally include motor, a leadscrew coupled to the motor, and an actuator arm coupled to the leadscrew. The motor can be configured to operate the leadscrew to move the actuator arm, and the actuator arm can be configured to move the switch from the first position to the second position.

Features, elements, and aspects described in the context of some embodiments may also be omitted, combined, or replaced by alternative features. Other features, objectives, advantages, and a preferred mode of making and using the claimed subject matter are described in greater detail below with reference to the accompanying drawings of illustrative embodiments.

### BRIEF DESCRIPTION OF THE DRAWINGS

The accompanying drawings illustrate some objectives, advantages, and a preferred mode of making and using some embodiments of the claimed subject matter. Like reference numbers represent like parts in the examples.

FIG. 1 is a schematic diagram of a system in a first state for controlling current flow in a circuit.

FIG. 2 is a schematic diagram of the system of FIG. 1 in a second state.

FIG. 3 is a schematic diagram illustrating an example of the system of FIG. 1 and FIG. 2 used to control access through an access point.

### DESCRIPTION OF EXAMPLE EMBODIMENTS

The following description of example embodiments provides information that enables a person skilled in the art to make and use the subject matter set forth in the appended claims, but it may omit certain details already well known in the art. The following detailed description is, therefore, to be taken as illustrative and not limiting.

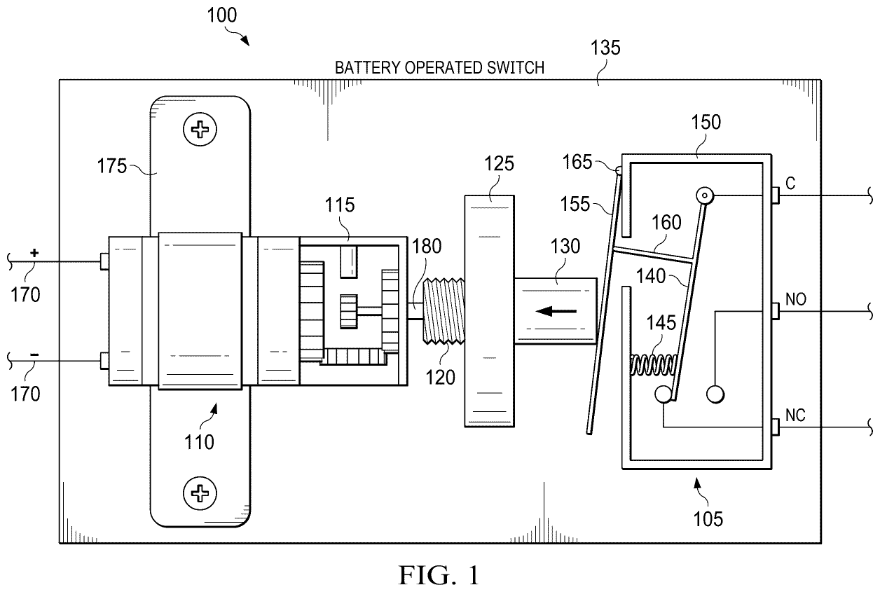

FIG. 1 is a schematic diagram of a system 100 for controlling current flow in a circuit (not shown). The system 100 of FIG. 1 generally comprises a switch 105 and an actuator 110. The actuator 110 generally comprises a motor 115, a leadscrew 120, a nut 125, and an actuator arm 130. In some examples, one or more components may be enclosed in and/or coupled to a housing 135.

The switch 105 of FIG. 1 comprises a common terminal C, a normally open terminal NO, a normally closed terminal NC, and a contact arm 140. The contact arm 140 can be configured to couple the common terminal C to the normally closed terminal NC in a first position and to the normally open terminal NO in a second position. For example, the contact arm 140 may be a spring-loaded arm having a first end coupled to the common terminal C and a second end that is movable between a contact coupled to the normally closed terminal NC and a contact coupled to the normally open terminal NO. A spring may bias the contact arm 140 toward the first position. In FIG. 1, for example, a spring 145 is positioned between a frame 150 and the contact arm 140 to bias the second end of the contact arm 140 toward the contact coupled to the normally closed terminal NC. The frame 150 may be coupled to the housing 135 to maintain the position of the switch 105 relative to the housing 135.

The switch 105 of FIG. 1 also comprises a lever 155 and a lever arm 160. The lever 155 may be coupled to the frame 150 as illustrated in the example of FIG. 1. In some examples, the lever 155 may be configured to rotate about a hinge 165. The lever arm 160 may be disposed between the contact arm 140 and the lever 155. In more specific examples, the lever arm 160 may have a first end coupled to the contact arm 140 and a second end coupled to the lever 155.

In some embodiments, the motor 115 may be a direct current motor and can be operated at a range of about three (3) volts to about twelve (12) volts. For example, a micro-gear motor capable of operating at three hundred (300) revolutions per minute and three (3) volts may be particularly useful in some embodiments. The motor 115 may be coupled to conductors 170, which may couple the motor 115 to a source of direct current to provide power to the motor 115. For example, the conductors 170 may be coupled to a battery (not shown) having a voltage in a range of about three (3) volts to about twelve (12) volts, and preferably less than six (6) volts. The motor 115 may be coupled to the housing 135 to maintain the position of the motor 115 relative to the housing 135. For example, a clamp 175 may secure the motor 115 of FIG. 1 to the housing 135.

The leadscrew 120 is generally a threaded shaft or rod, which may be coupled to the motor 115. The nut 125 may be threaded onto or otherwise coupled to the leadscrew 120. In more particular examples, the motor 115 may have or be coupled to a motor shaft 180, which can be coupled to the leadscrew 120. The motor 115 may be operable to rotate the motor shaft 180, and thereby the leadscrew 120. Rotation of the nut 125 may be restricted while allowing linear motion. For example, the nut 125 may have flat surfaces that can be retained by the housing 135 or restraining plates (not shown) coupled to the housing 135, which can prevent rotation of the nut 125 while allowing axial movement along the leadscrew 120.

In the example of FIG. 1, the actuator arm 130 is a shaft or rod. In other examples, the actuator arm 130 may comprise a plurality of shafts, arms, a separate linkage, or series of linkages. In some embodiments, the actuator arm 130 may be coupled to the nut 125.

The switch 105 of FIG. 1 is illustrated in a first state (a resting state) in which the lever 155 is open and there is no elastic force in the spring 145. The contact arm 140 is in the first position so that the common terminal C is coupled to the normally closed terminal NC. The actuator 110 of FIG. 1 is also illustrated in a first state in which the actuator arm 130 is disengaged from the lever 155 or otherwise maintains the lever 155 in the open position.

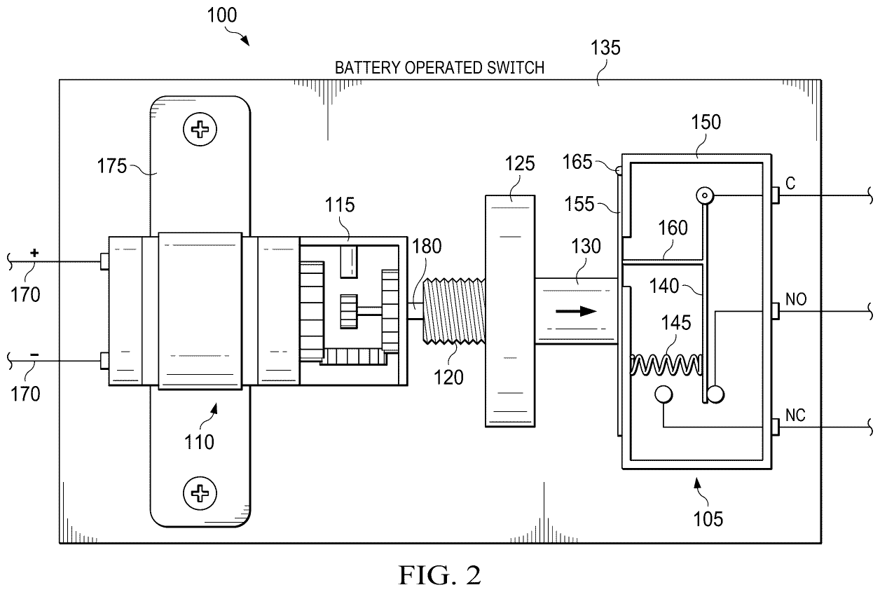

FIG. 2 is a schematic diagram of the system 100 of FIG. 1 in which the switch 105 is in a second state. For example, if power is provided to the motor 115 through the conductors 170, the motor 115 can rotate the motor shaft 180 in a first direction. The rotation of the motor shaft 180 in this first direction can rotate the leadscrew 120 in a first direction. Since the nut 125 is rotationally constrained, rotation of the leadscrew 120 can move the nut 125 axially relative to the leadscrew 120, which in turn can move the actuator arm 130. In the example of FIG. 2, the rotation of the leadscrew 120 in the first direction moves the nut 125 and the actuator arm 130 linearly toward the lever 155 from a first position to a second position until the actuator arm 130 rotates the lever 155 about the hinge 165 to a closed position. As the actuator arm 130 closes the lever 155, the lever 155 causes the lever arm 160 to move the contact arm 140 to the second position in which the common terminal C is coupled to the normally open terminal NO.

If the polarity of the power to the motor 115 is reversed, the motor 115 can rotate the motor shaft 180 in a second direction, which can rotate the leadscrew 120 in a second direction to return the nut 125 and the actuator arm 130 to the first position (as shown in the example of FIG. 1). As the actuator arm 130 moves to the second position, the spring 145 can return the contact arm 140 to the first position.

In general, components of the system 100 may be coupled directly or indirectly. For example, the motor 115 may be directly coupled to the motor shaft 180 and may be indirectly coupled to the actuator arm 130 through the nut 125. Coupling may include fluid, mechanical, thermal, electrical, or chemical coupling (such as a chemical bond), or some combination of coupling in some contexts. For example, the motor 115 may be mechanically coupled to the leadscrew 120 and may be electrically coupled to a battery. In some embodiments, components may also be coupled by virtue of physical proximity, contact, being integral to a single structure, or being formed from the same piece of material.

The system 100 may have a variety of practical applications. In some embodiments, the system 100 may be used to control access to a structure or other area through an access point, such as a door or an elevator, having an electronic lock. In other examples, the system 100 may be used to control access to other types of systems, such as charging stations. In some examples, the system 100 may be configured to close a circuit between the electronic lock and a power supply in a first position and to open the circuit in a second position.

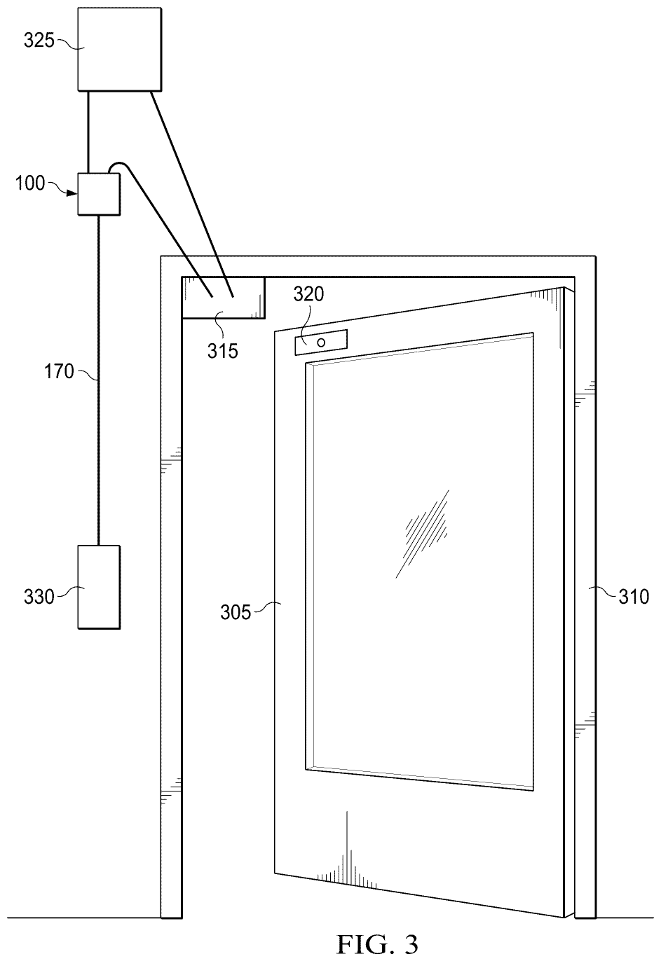

FIG. 3 is a schematic diagram illustrating an example of the system 100 that can be used to control access through an access point that comprises a door 305 and a door frame 310. In the example of FIG. 3, the electronic lock comprises a magnet 315 coupled to the door frame 310, and a magnetic plate 320 coupled to the door 305.

In some examples, the magnet 315 may be an electromagnet, which may be coupled to a power supply 325. In general, the power supply 325 can provide an electric current to the magnet 315 to produce a magnetic field. In some embodiments, the magnet 315 may require the power supply 325 provide an alternating current at 120 volts. In other embodiments, the magnet 315 may require direct current at 12 volts or 24 volts. The system 100 may be coupled to the magnet 315 and to the power supply 325. For example, the power supply 325 may have a first terminal that is electrically coupled to a first terminal of the magnet 315, and a second terminal that is electrically coupled to the common terminal C of the system 100. The magnet 315 may have a second terminal that is electrically coupled to the normally closed terminal NC of the system 100 so that the circuit between the magnet 315 and the power supply 325 is closed when the system 100 is in the first state (see FIG. 1).

In operation, the magnet 315 produces a magnetic field that is strong enough to keep the magnetic plate 320 locked to the magnet 315 if the power supply 325 provides current to the magnet 315 through the closed circuit between the magnet 315 and the power supply 325. If the circuit between the magnet 315 and the power supply 325 is opened, the magnetic plate 320 may be released from the magnet 315, allowing the door 305 to be opened.

In some embodiments, the system 100 may be coupled to an access control unit 330. The access control unit 330 may be configured to read or receive a signal from an identification unit (not shown), such as a radio frequency identifier (RFID), a magnetic stripe card, keypad, biometric scanner, or Bluetooth device. The access control unit 330 may be powered by relatively low-voltage, direct current source, such as a battery having a voltage in a range of about three (3) volts to about twelve (12) volts, and preferably less than six (6) volts. The access control unit 330 may be electrically coupled to the system 100 through the conductors 170.

In the example of FIG. 3, the access control unit 330 may control the system 100. For example, if the access control unit 330 determines that access should be allowed, the access control unit 330 can deliver power to the motor 115 through the conductors 170, which can cause the system 100 to change from the first state (FIG. 1) to the second state (FIG. 2). In the second state, the circuit between the magnet 315 and the power supply 325 is opened, and the magnetic plate 320 may be released from the magnet 315 so that the door 305 to be opened.

In some embodiments, the access control unit 330 may have a timer that reverses the polarity after access has been allowed, so that the system 100 returns to the first state.

The systems, apparatuses, and methods described herein may provide significant advantages. For example, some embodiments may be particularly advantageous for reducing the cost of operating and maintaining access to structures and systems. For example, some embodiments can be installed without installing additional power sources or connecting to utility power sources, which can significantly reduce installation cost and allow installation in locations without utility power.

While shown in a few illustrative embodiments, a person having ordinary skill in the art will recognize that the systems, apparatuses, and methods described herein are susceptible to various changes and modifications that fall within the scope of the appended claims.

Moreover, descriptions of various alternatives using terms such as “or” do not require mutual exclusivity unless clearly required by the context, and the indefinite articles “a” or “an” do not limit the subject to a single instance unless clearly required by the context. Components may also be combined or eliminated in various configurations for purposes of sale, manufacture, assembly, or use.

The claims may also encompass additional subject matter not specifically recited in detail. For example, certain features, elements, or aspects may be omitted from the claims if not necessary to distinguish the novel and inventive features from what is already known to a person having ordinary skill in the art. Features, elements, and aspects described in the context of some embodiments may also be omitted, combined, or replaced by alternative features serving the same, equivalent, or similar purpose without departing from the scope of the invention defined by the appended claims.

1. An apparatus for controlling current in a circuit, the apparatus comprising:
a motor, a leadscrew coupled to the motor, and an actuator arm coupled to the leadscrew;
a common terminal, a normally open terminal, a normally closed terminal, and a contact arm configured to couple the common terminal to the normally closed terminal in a first position and to the normally open terminal in a second position; and
a spring configured to bias the contact arm toward the first position;
wherein the motor is configured to operate the leadscrew to move the actuator arm, and the actuator arm is configured to move the contact arm from the first position to the second position.

2. The apparatus of claim 1, wherein the motor is a direct current motor and is configured to be operated at a range of about three volts to less than twelve volts.

3. The apparatus of claim 1, wherein the motor is a micro-gear direct current motor capable of operating at about three hundred revolutions per minute and three volts.

4. The apparatus of claim 1, wherein the motor is coupled to a battery having a voltage in a range of about three volts to about six volts.

5. (canceled)

6. (canceled)

7. The apparatus of claim 1, wherein the contact arm comprises a first end coupled to the common terminal and a second end that is movable between the first position and the second position.

8. The apparatus of claim 1, further comprising a frame, wherein the spring is disposed between the frame and the contact arm to bias the contact arm toward the first position.

9. The apparatus of claim 1, further comprising:
a frame;
a lever;
a hinge coupled to the frame and the lever; and
a lever arm disposed between the contact arm and the lever;
wherein the actuator arm is configured to rotate the lever around the hinge to move the contact arm from the first position to the second position.

10. The apparatus of claim 1, wherein:
the motor is configured to operate the leadscrew in a first direction and a second direction;
operating the leadscrew in the first direction moves the contact arm from the first position to the second position; and
operating the leadscrew in the second direction allows the spring to return the contact arm from the second position to the first position.

11. An apparatus for controlling current in a circuit, the apparatus comprising:
a housing;
a frame coupled to the housing;
a common terminal, a normally open terminal, and a normally closed terminal coupled to the frame;
a contact arm comprising a first end coupled to the common terminal and a second end that is movable from a first position to a second position, wherein the contact arm couples the common terminal to the normally closed terminal in the first position and to the normally open terminal in the second position;
a lever;
a hinge coupled to the frame and the lever;
a lever arm disposed between the contact arm and the lever;
a spring disposed between the frame and the contact arm to bias the contact arm toward the first position;
a leadscrew;
an actuator arm coupled to the leadscrew; and
a motor configured to be operated on direct current in a range of about three volts to less than twelve volts;
wherein the motor is configured to operate the leadscrew in a first direction to move the actuator arm toward the lever, rotating the lever around the hinge to move the contact arm from the first position to the second position; and
wherein the motor is configured to operate the leadscrew in a second direction to move the actuator arm away from the lever, allowing the spring to return the contact arm to the first position from the second position.

12. A system for controlling an access point, the system comprising:
an electronic lock;
a power supply coupled to the electronic lock;
a switch coupled to the electronic lock and the power supply, the switch configured to close a circuit between the electronic lock to the power supply in a first position and to open the circuit in a second position;
a spring configured to bias the switch toward the first position; and
a motor, a leadscrew coupled to the motor, and an actuator arm coupled to the leadscrew;
wherein the motor is configured to operate the leadscrew to move the actuator arm, and the actuator arm is configured to move the switch from the first position to the second position.

13. The system of claim 12, further comprising an access control unit coupled to the motor, the access control unit configured to delivery power to the motor to operate the leadscrew.

14. The system of claim 13, wherein the access control unit is configured to operate on a battery having a voltage in a range of about three volts to about twelve volts.

15. The system of claim 13, wherein the access control unit is configured to receive a signal from an identification unit and deliver power to the motor if the signal indicates access should be allowed.

16. The system of claim 15, wherein the access control unit is configured to reverse polarity after a period of time.

17. The system of claim 16, wherein:
the switch comprises:
a frame,
a common terminal, a normally open terminal, and a normally closed terminal coupled to the frame,
a contact arm comprising a first end coupled to the common terminal and a second end that is movable from the first position to the second position, wherein the contact arm couples the common terminal to the normally closed terminal in the first position and to the normally open terminal in the second position,
a lever,
a hinge coupled to the frame and the lever, and
a lever arm disposed between the contact arm and the lever;
the power supply is coupled to the common terminal;
the spring is disposed between the frame and the contact arm to bias the contact arm toward the first position; and
the motor is configured to operate the leadscrew in a first direction to move the actuator arm toward the lever, rotating the lever around the hinge to move the contact arm from the first position to the second position;
wherein the motor is configured to operate the leadscrew in a second direction to move the actuator arm away from the lever, allowing the spring to return the contact arm to the first position from the second position.
